(19) United States
(12) Patent Application Publication
(10) Pub. No.: US 2025/0369614 A1
(43) Pub. Date: Dec. 4, 2025

(54) AUGMENTED THERMAL FENCING OF A FUEL NOZZLE HEAT SHIELD

(71) Applicant: PRATT & WHITNEY CANADA CORP., Longueuil (CA)

(72) Inventors: Jayaprakash Kannan, North York (CA); Assaf Farah, Brossard (CA); Sri Sreekanth, Mississauga (CA)

(21) Appl. No.: 18/733,593

(22) Filed: Jun. 4, 2024

(51) Int. Cl. F23R 3/28; F02M 53/04

(52) U.S. Cl. CPC F23R 3/283; F02M 53/046

(57) ABSTRACT

A fuel injector includes a mount, a stem, a nozzle, and a heat shield. The stem extends from the mount. The nozzle is at a distal end of the stem opposite the mount and configured to discharge an oxidant-fuel mixture along a nozzle axis. The heat shield extends from the mount towards the nozzle. The heat shield includes a stem segment surrounding the stem and at least a portion of the nozzle and a compliant segment extending from the stem segment to the nozzle, a lip extending from the nozzle, or a cap surrounding the nozzle.

### BACKGROUND

The present disclosure relates generally to fuel injectors of gas turbine engines, and more particularly, thermal protection for fuel injectors.

Fuel injectors are exposed to high temperature gas during operation of gas turbine engines. Heat shields provide thermal protection by surrounding a portion of the fuel injector. Due to differential thermal growth between the heat shield and fuel injector, conventional heat shields often form a gap that permits ingress of high temperature gases between the heat shield and fuel injector and decreases the effectiveness of the thermal protection. Further development of heat shield design is desirable to improve thermal protection of the fuel injector that accommodates differential thermal growth and minimizes the coking risk in the fuel passages of the nozzle.

### SUMMARY

A fuel injector can include a mount, a stem, a nozzle, and a heat shield. The stem extends from the mount. The nozzle is at a distal end of the stem opposite the mount and configured to discharge an oxidant-fuel mixture along a nozzle axis. The heat shield extends from the mount towards the nozzle. The heat shield includes a stem segment and a complaint segment. The stems segment surrounds the stem and at least a portion of the nozzle. The compliant segment extends from the stem segment towards the nozzle or towards the mount.

### BRIEF DESCRIPTION OF THE DRAWINGS

FIG. 1 is a cross-sectional view of an example injector and heat shield that includes a compliant segment.

FIG. 2 is an enlarged cross-sectional view of the nozzle of the injector from FIG. 1 depicting features of the compliant segment in greater detail.

FIG. 3 is an enlarged cross-sectional view of another example nozzle and heat shield with a compliant segment extending from the heat shield to a lip of the nozzle.

FIG. 4 is an enlarged cross-sectional view of another example nozzle and heat shield with a compliant segment extending from the heat shield to a cap of the nozzle.

FIG. 5 is a cross-sectional view of another example injector and heat shield that includes a compliant segment.

### DETAILED DESCRIPTION

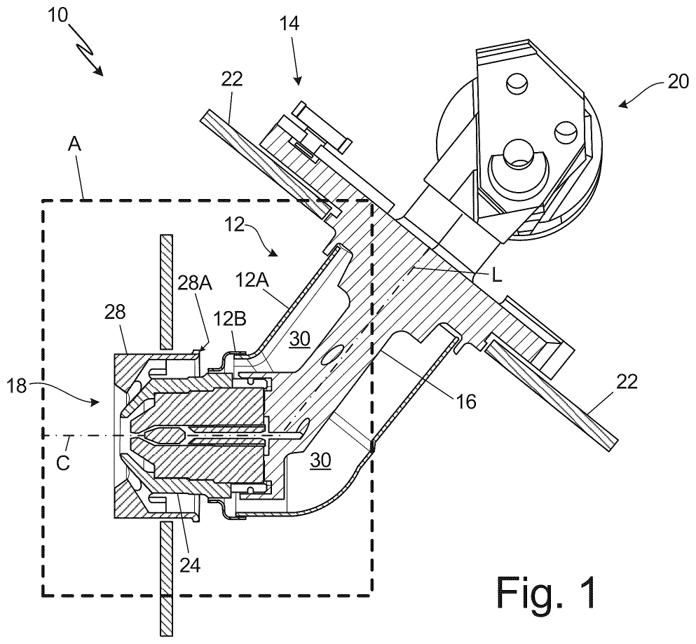

FIG. 1 is a cross-sectional view of injector 10 that includes heat shield 12. Heat shield 12 includes stem segment 12A that surrounds at least as portion of injector 10, and further includes compliant segment 12B that extends between stem segment 12A and injector 10 to eliminate a gap between a distal end of heat shield 12 and adjacent components of injector 10. Compliant segment 12B has reduced stiffness in axial and radial directions relative to stem segment 12A and injector components such that, in operation, compliant segment 12B permits differential displacement between heat shield 12 and injector 10 without forming a gap at the distal end of heat shield 12. Since gap is not present between the distal end of heat shield 12 and injector 10, leakage of high-temperature fluid into a cavity between heat shield 12 and injector 10 is greatly restricted, or prevented, and thereby provides improved thermal protection of injector 10.

While a particular injector 10 is depicted by FIG. 1, it shall be understood that heat shield 12, as described below, can be incorporated into other examples of injector 10, or other components exposed to high temperature gas or fluid. Injector 10 can include a single fuel path and a single air path in some examples. Other examples of injector 10 can include multiple fuel paths connected to a single fuel source, or multiple fuel passages connected to multiple fuel sources. Injector 10 can include additional air paths directed towards and/or between two or more fuel paths.

Injector 10 is a fuel delivery device installed within a combustor of a gas turbine engine. In operation, injector 10 delivers fuel and oxidant (e.g., air) at specified mass flow rates to provide an oxidant-fuel mixture within the combustor combustion chamber. As depicted, injector 10 includes heat shield 12, mount 14, stem 16, nozzle 18, and manifold 20. Heat shield 12, mount 14, stem 16, nozzle 18, and manifold 20 can be an assembly of components joined at respective interfaces to form injector 10. In some examples, components of injector 10 are joined using a brazing process and/or a welding process. In other examples, heat shield 12, mount 14, stem 16, nozzle 18, and manifold 20 describe regions of a monolithic body formed by, for example, an additive manufacturing process. Further, certain features of injector 10 can be formed by a machining process or other subtractive manufacturing.

Mount 14 supports injector 10 from stationary structure 22 of the gas turbine engine. One or more flanges, lips, and/or pilot diameters allow mount 14 to interface with stationary structure 22. Mount 14 further includes one or more fasteners, keys, and/or pins for affixing injector 10 relative to stationary structure 22 and the combustor of gas turbine engine. As depicted, mount 14 is a flange that abuts stationary structure 22, which can be a casing of gas turbine engine that surrounds the combustor. Mount 14 further includes a pilot diameter received within an opening of stationary structure 22 and may include fasteners (not shown) for affixing mount 14 to stationary structure 22.

Manifold 20 is outboard of mount 14 and includes supply lines fluidly communicating with a fuel source and/or one or more other adjacent injectors 10. Manifold can include one or more pipes, conduits, hoses, and/or internal passages to define supply lines, which communicate with one or more fuel passages of stem 16.

Stem 16 extends longitudinally from mount 14 through stationary structure 22 into combustion chamber of the combustor. Stem 16 includes one or more fuel passages in fluid communication with one or more supply passages of manifold 20. Stem 16 can extend linearly from mount 14 such that stem 16 is devoid of bends or elbows. In other examples, stem 16 can include one or more linear sections connected by respective bends such that a longitudinal axis of stem 16 represented by dashed line L changes at each bend relative to an adjacent linear section of stem 16. In yet another example, stem 16 can include one or more tubes extending from mount 14 to nozzle 18 in which each tube forms a fuel passage or an oxidant passage. As depicted, stem 16 extends radially inward from mount 14 relative to an axis of gas turbine engine. Stem 16 includes a bend spaced apart from mount and extends at an angle relative to the radial section of stem 16 to nozzle 18.

Nozzle 18 is disposed at a distal end of stem 16 within the combustion chamber and extends along nozzle axis C parallel to a distal portion of stem 16. Nozzle 18 includes a center body and one or more annular bodies concentrically disposed with respect to the center body to form one or more discharge fuel passages configured to direct fuel along nozzle axis C. Each of the one or more discharge fuel passages fluidly connects to at least one of the fuel passages of the stem 16 to define respective fuel paths between manifold 20 and nozzle 18. Further, the annular bodies of nozzle 18 form at least one gaseous passage for directing oxidant through nozzle 18 to mix with fuel discharged through fuel paths of injector 10.

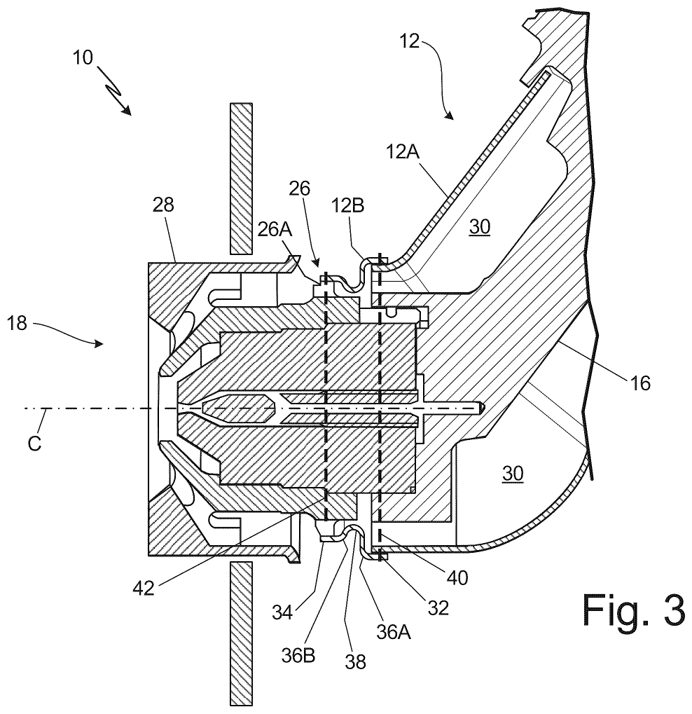

Nozzle 18 includes exterior annular body 24. Exterior annular body 24 is radially inboard of a distal end of heat shield 12 relative to nozzle axis C. In some examples, exterior annular body 24 includes lip 26 extending radially outward from exterior annular body 24 as depicted in FIG. 3. Exterior annular body 24 can be the outermost annular body of nozzle 18 relative to nozzle axis C in certain examples of nozzle 18. In other examples, such as the example depicted by FIG. 1, nozzle 18 includes one or more bodies outboard of exterior annular body 24 such as cap 28. Cap 28 and exterior annular body 24 can form one or more oxidant passages extending through nozzle 18. As shown by FIG. 1, cap 28 includes inlet end 28A adjacent to heat shield 12 that cooperates with lip 26 to form an entrance to the one or more oxidant passages, which is not obstructed by heat shield 12.

Heat shield 12 includes stem segment 12A and compliant segment 12B. Stem segment 12A extends from mount 14 along longitudinal axis L to surround stem 16 and at least a portion of nozzle 18. In some examples, stem segment 12A can surround an entirety of stem 16 and nozzle 18. Stem segment 12A is spaced from stem 16 and nozzle 18 to form chamber 30. Stagnant gas (e.g., air) within chamber 30 provides thermal protection for stem 16 and nozzle 18. A proximal end of stem segment 12A affixes to mount 14 and can be concentric with mount 14 and/or stem 16 at the proximal end. Stem segment 12A extends along longitudinal axis L towards nozzle 18 and can include contours and/or bends that conform a shape of heat shield 12 to at least some portions of stem 16 and/or 18.

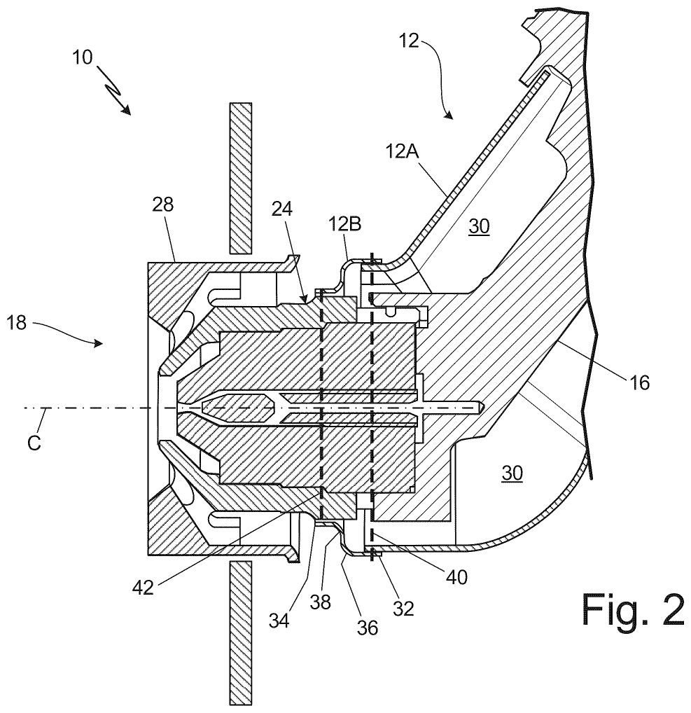

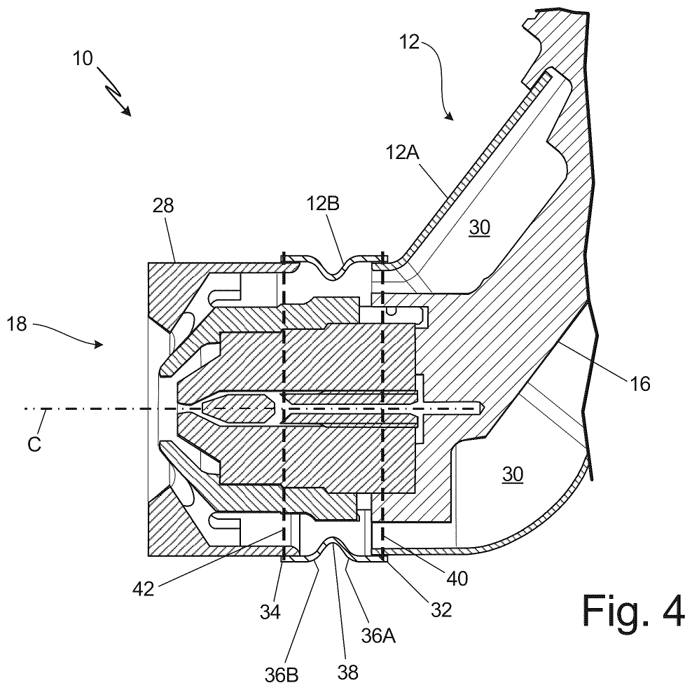

Compliant segment 12B extends between a distal end of stem segment 12A to an axial adjacent and/or radially adjacent component of nozzle 18 and/or cap 28. As depicted in FIG. 1 and the enlarged view in FIG. 2, compliant segment 12B extends between stem segment 12B and exterior annular body 24. In other examples, compliant segment 12B can extend between stem segment 12A and lip 26 of nozzle 18, as depicted by FIG. 3, or between stem segment 12A and cap 28 as depicted by FIG. 4. Compliant segment 12B is joined to at least one of stem segment 12A, nozzle 18 (e.g., exterior annular body 24), and cap 28. In some examples, compliant segment 12B is joined to one of stem segment 12A, nozzle 18 (e.g., exterior annular body 24), and cap 28 and forms sliding contact with a different one of stem segment 12A, nozzle 18 (e.g., exterior annular body 24), and cap 28. In yet other examples, compliant segment 12B is joined to two of stem segment 12A, nozzle 18 (e.g., exterior annular body 24), and cap 28.

Opposing ends of compliant segment 12B can be offset axially and/or radially relative to each other to accommodate geometry of nozzle 18 and/or cap 28. Intermediate sections of compliant segment 12B can be contoured to provide a smooth and continuous transition between the opposing ends. For instance, compliant segment 12B can include concave and/or convex sections as well as linear sections to form profile of compliant segment 12B as viewed in a radial cross-section through nozzle axis C. Offset opposing ends and contoured intermediate sections can be tailored to achieve a desired stiffness of compliant segment 12B.

Compliant segment 12B has a stiffness that is less than corresponding stiffnesses of stem segment 12A, stem 16, nozzle 18, and cap 28 such that relative displacement between heat shield 12 and adjacent components (e.g., nozzle 18 and cap 28) deflects portions of compliant segment 12B to a greater degree than stem segment 12A, stem 16, nozzle 18, and cap 28. The stiffness of compliant segment 12B can be expressed as a lateral stiffness, radial stiffness, and/or an axial stiffness relative to nozzle axis C, among other possible stiffness expressions. Lateral stiffness is the force per unit displacement imposed on compliant segment 12B by relative lateral displacement between nozzle 18 (or cap 28) and stem segment 12A. Radial stiffness is the force per unit displacement imposed on compliant segment 12B by relative radius changes between nozzle 18 (or cap 28) and stem segment 12A. Axial stiffness is the force per unit displacement imposed on compliant segment 12B by relative axial displacement between nozzle 18 (or cap 28) and stem segment 12A. In some examples, the lateral stiffness, the radial stiffness, and/or the axial stiffness of compliant segment 12B can be at least one half of a corresponding stiffness of stem segment 12A, nozzle 18, stem 16, and/or cap 28. In other examples, the lateral stiffness, the radial stiffness, and/or the axial stiffness of compliant segment 12B can be at least one fifth of a corresponding stiffness of stem segment 12A, nozzle 18, stem 16, and/or cap 28.

In operation, exposure of high temperature combustion gas to injector 10 increases body temperatures of heat shield 12, exposed portions of nozzle 18 and cap 28, if any, and to a lesser degree stem 16, mount 14, and manifold 20. Since heat shield 12 forms an exterior of injector 10, heat shield 12 experiences a greater temperature increase relative to stem 16 and protected portions of nozzle 18 and cap 28. As such, the net thermal growth of stem 16, nozzle 18, and cap 28 can be less than thermal growth of heat shield 12 at interfaces with compliant segment 12B. Under these conditions, compliant segment 12B displaces radially and/or axially to a greater degree relative to nozzle axis C than stem segment 12A, stem 16, nozzle 18, and cap 28 and thereby maintains contact between compliant section 12B of heat shield 12 and nozzle 18, or cap 28 without imposing unnecessary stress into injector 10.

FIG. 2 is an enlarged view of nozzle 18 FIG. 1 depicting features of compliant segment 12B in greater detail. Heat shield 12, stem 16, nozzle 18, and cap 28 are shown. Compliant segment 12B between stem segment 12A of heat shield 12 and exterior annular body 24 of nozzle 18.

As depicted, compliant segment 12B includes first end 32 and second end 34 at opposing ends thereof. First end 32 extends linearly and concentrically to the distal end of stem segment 12A. First end 32 can contact or can be joined to a distal end of stem segment 12A. As shown, first end 32 can contact an exterior surface of stem segment 12A. In other examples, first end 32 can contact or can be joined to an interior surface of stem segment 12A. Second end 34 extends linearly and concentrically to an outer peripheral surface of exterior annular body 24. Second end 34 can contact or can be joined to exterior annular body 24 of nozzle 18. Second end 34 is offset axially towards cap 28 and away from stem segment 12A and offset radially towards exterior annular body 24 of nozzle 18.

Compliant segment 12B includes convex section 36 and concave section 38 to accommodate the depicted axial and radial offsets as well as to provide lateral, radial, and/or axial stiffness as described above. Convex section 36 is connected to and extends from first end 32 in an axially forward and radially inward direction relative to nozzle axis C. Concave section 38 connects to and extends from convex section 36 in a radially inward and axially forward direction to join convex section 36 to second end 34. Collectively, first end 32, convex section 36, concave section 38 and second end 34 form an S-shaped cross-sectional profile of compliant segment 12B.

Variations of the compliant segment 12B can join first end 32 to stem segment 12A and/or can join second end 34 to exterior annular body 24 at along respective interfaces represented by dashed lines 40 and 42. For instance, first end 32 can be joined to stem segment 12A along interface line 40 and second end 34 can contact exterior annular body 24 of nozzle 18 to form a sliding joint. In another example, first end 32 can contact exterior surface or interior surface of stem segment 12A to form a sliding joint and second end 34 can join with exterior annular body 24 along interface line 42. In yet another example, first end 32 and second end 34 can be joined respective interfaces on stem segment 12A and exterior annular body 24.

FIG. 3 is an enlarged view of another example of nozzle 18 and compliant segment 12B. Heat shield 12, stem 16, nozzle 18, and cap 28 are shown. As shown, exterior annular body 24 includes lip 26, which extends outward from exterior annular body 24. Lip 26 can extend in a radial direction relative to nozzle axis C such that flanks of lip 26 are normal to nozzle axis C. In other examples, lip 26 can extend radially and axially relative to nozzle axis C and have flanks oblique to nozzle axis C. The exterior surface of lip 26 extends axially to join flanks of lip 26. As shown, lip 26 is disposed between heat shield 12 and cap 28 and includes chamfer 26A to improve oxidant flow into one or more oxidant passages of nozzle 18.

As depicted, compliant segment 12B includes first end 32 and second end 34 at opposing ends thereof. First end 32 extends linearly and concentrically to the distal end of stem segment 12A. First end 32 can contact or can be joined to a distal end of stem segment 12A. As shown, first end 32 can contact an exterior surface of stem segment 12A. In other examples, first end 32 can contact or can be joined to an interior surface of stem segment 12A. Second end 34 extends linearly and concentrically to the exterior surface of lip 26. Second end 34 can contact or can be joined to lip 26 of nozzle 18. Second end 34 is offset axially towards cap 28 (i.e., away from stem segment 12A) and offset radially inwards towards lip 26 of nozzle 18. In an alternative version, the exterior surface of lip 26 can be radially outward from a distal end of stem segment 12A such that second end 34 is offset radially outward relative to the distal end of stem segment 12A.

Compliant segment 12B includes, in series, first convex section 36A, concave section 38, and second convex section 36B to accommodate the depicted axial and radial offsets as well as to provide lateral, radial, and/or axial stiffness as described above. First convex section 36 is connected to and extends from first end 32 in an axially forward and radially inward direction relative to nozzle axis C. Concave section 38 connects to and extends from convex section 36 in a radially inward and axially forward direction to join first convex section 36 to second convex section 36B. Second convex section 36B joins to and extends from concave section 38 to connect with second end 34. Collectively, first end 32, first convex section 36A, concave section 38, second convex section 36B, and second end 34 form an undulated cross-sectional profile of compliant segment 12B.

Variations of the compliant segment 12B can join first end 32 to stem segment 12A and/or can join second end 34 to lip 26 at along respective interface lines 40 and 42. For instance, first end 32 can be joined to stem segment 12A along interface line 40 and second end 34 can contact lip 26 to form a sliding joint. In another example, first end 32 can contact exterior surface or interior surface of stem segment 12A to form a sliding joint, and second end 34 can join with lip 26 along interface line 42. In yet another example, first end 32 and second end 34 can be joined respective interfaces on stem segment 12A and lip 26.

FIG. 4 is an enlarged view of another example of nozzle 18 and compliant segment 12B. Heat shield 12, stem 16, nozzle 18, and cap 28 are shown. Compliant segment 12B extends between stem segment 12A of heat shield 12 and cap 28.

As depicted, compliant segment 12B includes first end 32 and second end 34 at opposing ends thereof. First end 32 extends linearly and concentrically to the distal end of stem segment 12A. First end 32 can contact or can be joined to a distal end of stem segment 12A. As shown, first end 32 can contact an exterior surface of stem segment 12A. In other examples, first end 32 can contact or can be joined to an interior surface of stem segment 12A. Second end 34 extends linearly and concentrically to cap 28. Second end 34 can contact or can be joined to an exterior surface or an interior surface of cap 28. Second end 34 is offset axially towards cap 28 (i.e., away from stem segment 12A) and offset radially outwards towards cap 28. In an alternative version, an interior surface and/or an exterior surface of cap 28 can be sized such that second end 34 is offset radially inward relative to a distal end of stem segment 12A.

Compliant segment 12B includes, in series, first convex section 36A, concave section 38, and second convex section 36B to accommodate the depicted axial and radial offsets as well as to provide lateral, radial, and/or axial stiffness as described above. First convex section 36A is connected to and extends from first end 32 in an axially forward and radially inward direction relative to nozzle axis C. Concave section 38 connects to and extends from convex section 36 in a radially inward and axially forward direction to join first convex section 36A to second convex section 36B. Second convex section 36B joins to and extends from concave section 38 to connect with second end 34. Collectively, first end 32, first convex section 36A, concave section 38, second convex section 36B, and second end 34 form an undulated cross-sectional profile of compliant segment 12B.

Variations of the compliant segment 12B can join first end 32 to stem segment 12A and/or can join second end 34 to cap 28 at along respective interface lines 40 and 42. For instance, first end 32 can be joined to stem segment 12A along interface line 40 and second end 34 can contact cap 28 to form a sliding joint. In another example, first end 32 can contact exterior surface or interior surface of stem segment 12A to form a sliding joint, and second end 34 can join with cap 28 along interface line 42. In yet another example, first end 32 and second end 34 can be joined respective interfaces on stem segment 12A and cap 28.

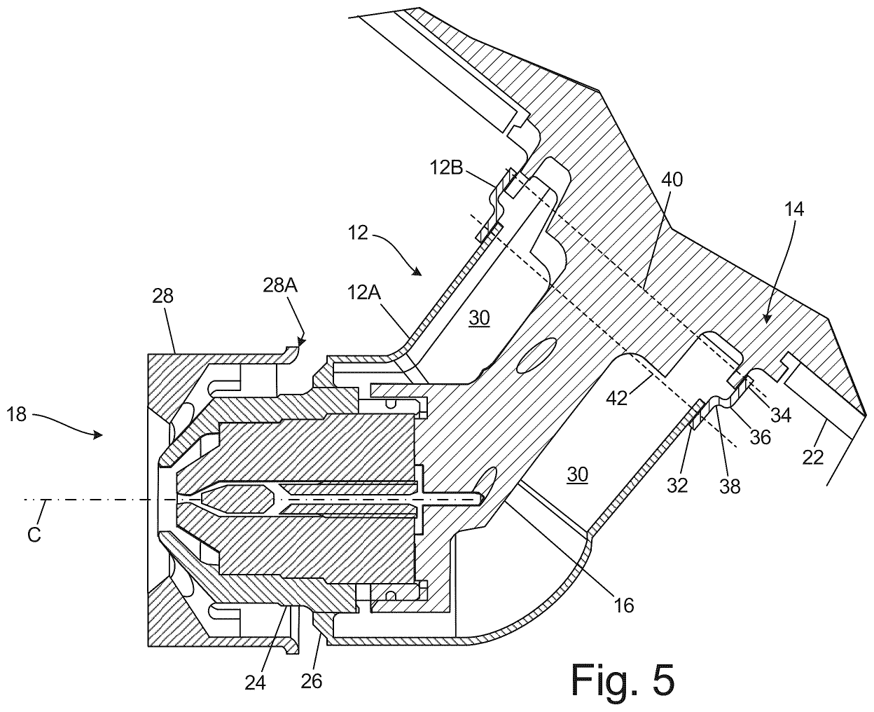

FIG. 5 is an enlarged view of another example of injector 10 that includes compliant segment 12B. Heat shield 12, mount 14, stem 16, nozzle 18, and cap 28 are shown. Compliant segment 12B extends between stem segment 12A of heat shield 12 and mount 14 rather than nozzle 18. Further, segment 12A is affixed to nozzle 18 rather than mount 14. For example, a distal end of segment 12A can be integral with, welded, brazed, or otherwise mechanically attached to an exterior annular body of nozzle 18. In some examples, stem segment 12A is joined to lip 26 as depicted in FIG. 5. The proximal end of stem segment 12A is spaced from mount 14 such that compliant segment 12B joins stem segment 12A to mount 14.

As depicted, compliant segment 12B includes first end 32 and second end 34 at opposing ends thereof. First end 32 extends linearly and concentrically to a proximal end of stem segment 12A. First end 32 can contact or can be joined to a proximal end of stem segment 12A. As shown, first end 32 can contact an exterior surface of stem segment 12A. In other examples, first end 32 can contact or can be joined to an interior surface of stem segment 12A. Second end 34 extends linearly and concentrically to mount 14. Second end 34 can contact or can be joined to an exterior surface or an interior surface of mount 14. Second end 34 is offset axially towards mount 14 (i.e., away from stem segment 12A) and offset radially outwards towards mount 14 relative to longitudinal axis L. In an alternative version, an interior surface and/or an exterior surface of mount 14 can be sized such that second end 34 is offset radially inward relative to a proximal end of stem segment 12A.

Compliant segment 12B includes convex section 36 and concave section 38 to accommodate the depicted axial and radial offsets as well as to provide lateral, radial, and/or axial stiffness as described above. Concave section 38 is connected to and extends from first end 32 along longitudinal axis L towards mount 14 and extends radially outward relative to longitudinal axis L. Convex section 36 connects to and extends from concave section 38 in a radially outward and axially rearward direction (i.e., towards mount 14) to join convex section 36 to second end 34. Collectively, first end 32, convex section 36, concave section 38 and second end 34 form an S-shaped cross-sectional profile of compliant segment 12B.

Variations of the compliant segment 12B can join first end 32 to stem segment 12A and/or can join second end 34 to mount 14 along respective interfaces represented by dashed lines 40 and 42. For instance, first end 32 can be joined to stem segment 12A along interface line 40 and second end 34 can contact mount 14 to form a sliding joint. In another example, first end 32 can contact exterior surface or interior surface of stem segment 12A to form a sliding joint and second end 34 can join with mount 14 along interface line 42. In yet another example, first end 32 and second end 34 can be joined respective interfaces on stem segment 12A and mount 14.

### Discussion of Possible Embodiments

The following are non-exclusive descriptions of possible embodiments of the present invention.

a Fuel Injector and Heat Shield with a Compliant Segment

A fuel injector according to an example embodiment of this disclosure includes, among other possible things, a mount, a stem, a nozzle, and a heat shield. The stem extends from the mount. The nozzle is at a distal end of the stem opposite the mount that is configured to discharge an oxidant-fuel mixture along a nozzle axis. The heat shield extends from the mount towards the nozzle. The heat shield includes a stem segment and a compliant segment. The stem segment surrounds the stem and at least a portion of the nozzle. The compliant segment extends from the stem segment. A stiffness of the compliant segment is less than a stiffness of the stem segment.

The fuel injector of the preceding paragraph can optionally include, additionally and/or alternatively, any one or more of the following features, configurations and/or additional components.

A further embodiment of the foregoing fuel injector, wherein the compliant segment can extend from the stem segment to the nozzle.

A further embodiment of any of the foregoing fuel injectors, wherein the compliant segment can be joined to the stem segment and can form a sliding joint with the nozzle.

A further embodiment of any of the foregoing fuel injectors, wherein the compliant segment can form a sliding joint with the stem segment and can be joined to the nozzle.

A further embodiment of any of the foregoing fuel injectors, wherein the compliant segment can be joined to the nozzle and the stem segment.

A further embodiment of any of the foregoing fuel injectors, wherein the nozzle can include an exterior annular body.

A further embodiment of any of the foregoing fuel injectors further comprising a lip extending outward from the exterior annular body.

A further embodiment of any of the foregoing fuel injectors, wherein the compliant segment can extend from the stem segment to the lip.

A further embodiment of any of the foregoing fuel injectors, wherein the compliant segment can be joined to the stem segment and can form a sliding joint with the lip.

A further embodiment of any of the foregoing fuel injectors, wherein the compliant segment can form a sliding joint with the stem segment and can be joined to the lip.

A further embodiment of any of the foregoing fuel injectors, wherein the compliant segment can be joined to the nozzle and the lip.

A further embodiment of any of the foregoing fuel injectors can include a cap surrounding and at least partially overlapping the nozzle.

A further embodiment of any of the foregoing fuel injectors, wherein the compliant segment can extend from the stem segment to the cap.

A further embodiment of any of the foregoing fuel injectors, wherein the compliant segment can be joined to the stem segment and can form a sliding joint with the cap.

A further embodiment of any of the foregoing fuel injectors, wherein the compliant segment can form a sliding joint with the stem segment and can be joined to the cap.

A further embodiment of any of the foregoing fuel injectors, wherein the compliant segment can be joined to the nozzle and the cap.

A further embodiment of any of the foregoing fuel injectors, wherein the compliant segment can have a first end and a second end opposite the first end.

A further embodiment of any of the foregoing fuel injectors, wherein the first end of the compliant segment can be joined the stem segment.

A further embodiment of any of the foregoing fuel injectors, wherein the first end of the compliant segment can form a sliding joint with the stem segment.

A further embodiment of any of the foregoing fuel injectors, wherein the second end of the compliant segment can be joined to the nozzle.

A further embodiment of any of the foregoing fuel injectors, wherein the first end of the compliant segment can form a sliding joint with the nozzle.

A further embodiment of any of the foregoing fuel injectors, wherein the second end of the compliant segment can be joined to the lip.

A further embodiment of any of the foregoing fuel injectors, wherein the first end of the compliant segment can form a sliding joint with the lip.

A further embodiment of any of the foregoing fuel injectors, wherein the second end of the compliant segment can be joined to the cap.

A further embodiment of any of the foregoing fuel injectors, wherein the first end of the compliant segment can form a sliding joint with the cap.

A further embodiment of any of the foregoing fuel injectors, wherein the first end of the compliant segment can be offset radially relative to the second end of the compliant segment opposite the first end.

A further embodiment of any of the foregoing fuel injectors, wherein the first end of the compliant segment can be offset axially relative to the second end of the compliant segment opposite the first end.

A further embodiment of any of the foregoing fuel injectors, wherein the compliant segment can include a convex section.

A further embodiment of any of the foregoing fuel injectors, wherein the compliant segment can include a concave section.

A further embodiment of any of the foregoing fuel injectors, wherein the convex section can be joined to the first end of the compliant segment.

A further embodiment of any of the foregoing fuel injectors, wherein the concave section can be joined to the convex section and the second end of the compliant segment.

A further embodiment of any of the foregoing fuel injectors, wherein a stiffness of the compliant segment can be less than or equal to one half a stiffness of the stem segment.

A further embodiment of any of the foregoing fuel injectors, wherein the compliant segment can include a first convex section and second convex section.

A further embodiment of any of the foregoing fuel injectors, wherein the first convex section can be joined to the first end of the compliant segment.

A further embodiment of any of the foregoing fuel injectors, wherein the second convex section can be joined to the second end of the compliant segment.

A further embodiment of any of the foregoing fuel injectors, wherein the compliant segment can include a concave section joined to the first convex section and the second convex section.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fuel injector comprising:
a mount;
a stem extending from the mount;
a nozzle at a distal end of the stem opposite the mount configured to discharge an oxidant-fuel mixture along a nozzle axis; and
a heat shield extending from the mount towards the nozzle, the heat shield comprising:
a stem segment surrounds the stem and at least a portion of the nozzle; and
a compliant segment extending from the stem segment to the nozzle, wherein the compliant segment is joined to at least one of the stem segment and the nozzle, and wherein a stiffness of the compliant segment is less than a stiffness of the stem segment.

2. The fuel injector of claim 1, wherein the compliant segment is joined to the stem segment and forms a sliding joint with the nozzle.

3. The fuel injector of claim 1, wherein the compliant segment is joined to the nozzle and forms a sliding joint with the stem segment.

4. The fuel injector of claim 1, wherein the compliant segment is joined to the nozzle and the stem segment.

5. The fuel injector of claim 1, wherein a first end of the compliant segment is offset radially and axially relative to the nozzle axis from a second end of the compliant segment opposite the first segment.

6. The fuel injector of claim 5, wherein the compliant segment includes a convex section joined to the first end and a concave section joined to the convex section and the second end.

7. A fuel injector comprising:
a mount;
a stem extending from the mount;
a nozzle at a distal end of the stem opposite the mount configured to discharge an oxidant-fuel mixture along a nozzle axis; and
a heat shield extending from the mount towards the nozzle, the heat shield comprising:
a stem segment surrounds the stem and at least a portion of the nozzle; and
a compliant segment extending from the stem segment to the nozzle, wherein the compliant segment is joined to at least one of the stem segment and the nozzle, and wherein a stiffness of the compliant segment is less than or equal to one half a stiffness of the stem segment.

8. The fuel injector of claim 7, wherein the compliant segment includes a first end and a second end opposite the first end, and wherein the first end is offset radially and axially from the second end.

9. The fuel injector of claim 8, wherein the compliant segment includes a convex section joined to the first end and a concave section joined to the second end and the convex section.

10. The fuel injector of claim 9, wherein the compliant segment is joined to the stem segment and forms a sliding joint with the nozzle.

11. The fuel injector of claim 9, wherein the compliant segment is joined to the nozzle and forms a sliding joint with the stem segment.

12. The fuel injector of claim 9, wherein the compliant segment is joined to the nozzle and the stem segment.

13. A fuel injector comprising:
a mount;
a stem extending from the mount;
a nozzle at a distal end of the stem opposite the mount configured to discharge an oxidant-fuel mixture along a nozzle axis;
a cap surrounding and at least partially overlapping the nozzle; and
a heat shield extending from the mount towards the nozzle, the heat shield comprising:
a stem segment surrounds the stem and at least a portion of the nozzle; and
a compliant segment extending from the stem segment to the cap, wherein the compliant segment is joined to at least one of the stem segment and the cap, and wherein a stiffness of the compliant segment is less than a stiffness of the stem segment.

14. The fuel injector of claim 13, wherein the compliant segment is joined to the stem segment and forms a sliding joint with the cap.

15. The fuel injector of claim 13, wherein the compliant segment is joined to the cap and forms a sliding joint with the stem segment.

16. The fuel injector of claim 13, wherein the compliant segment is joined to the cap and the stem segment.

17. The fuel injector of claim 13, wherein a first end of the compliant segment is offset axially along the nozzle axis from a second end of the compliant segment opposite the first segment.

18. The fuel injector of claim 17, wherein the compliant segment includes a first convex section joined to the first end, a second convex section joined to the second end, and a concave section joined to the first convex section and the second convex section.

19. The fuel injector of claim 17, wherein the compliant segment includes a first concave section joined to the first end, a second concave section joined to the second end, and a convex section joined to the first concave section and the second concave section.

20. The fuel injector of claim 13, wherein a stiffness of the compliant segment is less than or equal to one half a stiffness of the stem section.
